(19) United States
(12) Patent Application Publication
(10) Pub. No.: US 2005/0138039 A1
(43) Pub. Date: Jun. 23, 2005

(54) Method and system for tailoring metamodel requirements capture processing to varying users

(76) Inventor: Robert L. Hagen, Plano, TX (US)

Correspondence Address: FORTKORT GRETHER + KELTON LLP, 8911 N. CAPITAL OF TEXAS HWY., SUITE 3200, AUSTIN, TX, 78759, US

(21) Appl. No.: 10/738,903

(22) Filed: Dec. 17, 2003

(51) Int. Cl. G06F 17/00

(52) U.S. Cl. 707/100

(57) ABSTRACT

A user-variable method and system (160) for capturing and developing metamodel system requirements according to the capabilities of a predetermined set of metamodel users includes the steps and instructions for identifying a set of metamodel requirements for information useable by a system metamodel (162). The invention associates (164) a plurality of metamodel requirements components (182, 274) with the metamodel requirements. The method and system permit tailoring (166) the plurality of metamodel requirements components to a predetermined set of metamodel users. Following the tailoring function (166), the present invention may integrate (168) existing metamodels for then setting up (170) the metamodel for use by the ultimate metamodel user in the metamodel requirements capture step (174). The invention, further, graphically represents (172) the tailored plurality of metamodel requirements components according to the needs and capabilities of a predetermined set of metamodel users.

### TECHNICAL FIELD OF INVENTION

This invention, in general, relates to computer modeling software and related systems, and, more particularly, to a method and system for tailoring metamodel requirements capture processing to varying metamodel domain subject matter experts (SMEs) and other similar users.

### BACKGROUND OF THE INVENTION

Computer software systems effectively model many types of physical and organizational systems. One type of modeling system may be an object-oriented modeling system. An object-oriented modeling system establishes a computer-based environment replicating an actual environment or interactive system or set of systems. Object-oriented modeling systems constitute objects, relationships, and models, which are sets of object types and relationship types, etc., and are implemented in a mark-up language such as XML. One such object-oriented modeling environment is known as a metamodeling environment.

A metamodeling environment enables building models of business processes, such as an enterprise for which an enterprise architecture model may be developed. The metamodel addresses the need to understand increasingly complex enterprises, enabling decision makers and those carrying out the everyday work of sharing and implementing a common understanding, which may be represented as a visual model. The metamodeling model forms the basis for making informed decisions, since it becomes possible to reveal the complex interplay within the enterprise model.

An enterprise architecture model enables the illustration and depiction of enterprises and their ongoing processes, customers and suppliers. A metamodeling environment for an enterprise provides an illustrative domain for depicting how processes and relationships within an enterprise interact with one another rise. A desired metamodeling system does not restrict the user to a particular methodology for modeling, but provides templates for the modeling of different domains. The metamodel also permits the author to provide data and instructions directly into the model or import data from other applications, as well as to analyze models and access data outside of the model.

In field of enterprise architecture, the strengths of a metamodeling system clearly appear. In order to optimize the use of information technology by complex, global organizations, enterprise architects use such a tool to not only represents complexity, but also to analyze such complexity. This allows them to produce intelligible output to many different user groups quickly and completely.

In modifying or revising an existing metamodel or creating a new metamodel, it has been found difficult to modify the metamodel in an expeditious and interactive way. One problem relating to this difficulty has to do with the problem of not being able to iteratively change an existing model in the event that the business processes changes. Because of the complexity of the different work processes, the relationships and the underlying of classes that exist within a given model, it is difficult to change an existing model without iteratively communicating between the program developers and those individuals tasked with using and revealing the model that the developers developed.

There are four types of tools that a metamodel may use. These include (1) data modeling tools; (2) software development tools; (3) repository tools; and (4) metamodel development tools. Neither individually nor collectively do these tools satisfy all of the needs for an effective and efficient metamodeling system.

For example, data modeling tools will build logical data models and generate schemas. These tools will work fine, if the audience is satisfied with traditional databases and interfaces, to capture requirements in for formal data modeling structures. However, this is often not the case for many users who could take advantage of the metamodels for an enterprise architecture. Software development tools have a similar life cycle, but the resulting code generates traditional applications rather than modeling tools. Also, software development tools are often not sufficiently flexible for the needs of business-oriented users who need these tools for the early stages of the metamodel requirements capture process. Repository tools have application program interfaces supporting the development of tool storage. While these may act as a data storage device, they lack a graphical interface and provide no logical facility for gathering requirements.

Finally, known metamodel development tools do not facilitate the full lifecycle of metamodel development. Also, the known metamodel development tools fail to either tailor the visualization of the requirements capture to the audience's needs or capture metadata about the metamodel object types. One metamodel development tool addresses the design stage of metamodel requirements. However, such a system is generally text based and only focuses on the metamodel physical level for the Metis® metamodel language. In such a system, the object types coded textually are Metis® metamodel object types. Such a metamodel development tool fails to provide any visual models of metamodel requirements or logical design.

In the metamodel design, there is the need to review the metamodel components rapidly, enabling timely reviews by the team and the subject matter experts.

There is also a need for a metamodeling system that allows for easy or ready review of a developing metamodel system, without requiring a complete development of the metamodel system.

There is a need for a method and system tool that facilitates metamodel development processes, without the need for all participants in the development group to understand the system development lifecycles or the particular techniques such as UML.

There is a further need for the ability to obtain metamodel requirements from subject matter experts (SMEs) with different levels of metamodel system experience. In the event that the SME is not a system architect, there is a need for means by which to obtain metamodel requirement sets.

### SUMMARY OF THE INVENTION

In accordance with the present invention, there is provided a method and system for tailoring metamodel requirements capture processing to varying users that substantially eliminates or reduces the disadvantages and problems associated with prior methods and systems for capturing metamodel system requirements.

One aspect of the present invention is a SME-variable -method and system for capturing and developing metamodel system requirements according to the capabilities of a predetermined set of metamodel domain SMEs. The method and system include the steps and instructions for identifying a set of metamodel requirements for information useable by a system metamodel. The invention associates a plurality of metamodel requirements components with the metamodel requirements. The method and system tailor the plurality of metamodel requirements components to a predetermined set of metamodel users. The invention, further, graphically represents the tailored plurality of metamodel requirements components according to the needs and capabilities of a predetermined set of metamodel users. The tailoring functions of the method and system may involve tailoring the plurality of metamodel requirements components by aggregating existing metamodel requirements components into a plurality of metamodel requirements components, as well as adding the tailored metamodel requirements components to a domain specific model of the associated metamodel.

Another aspect of the present invention is a metamodel requirements capture process that begins with configuring the MRC tool to the needs of the audience. In business areas of an enterprise, referred to here as domains, an SME may be generally accustomed to particular graphical or PowerPoint® presentations to represent their domain (area of expertise). The process of the present invention shows this familiar graphic representation to the audience of metamodel requirements capture process. This familiar representation facilitates the capture of metamodel information and effectively introduces the domain SME to the abstract concepts of metamodeling. Accordingly, the metamodel requirements capture method and system of the present invention provide the technical advantage of a quick, user-friendly way to supply necessary information for developing a useable metamodel.

Still another technical advantage of the present invention its use in conjunction with an automated metamodel file generation system. By associating the metamodel requirements capture process of the present invention with an automated metamodel file generation system, it is possible to easily populate even the most robust metamodel system associated with a very complex underlying model, such as a large enterprise architecture model. This combination materially enhances the quality and speed of metamodel and subsequent model development and maintenance.

The metamodel capture process of the present invention provides the ability to tailor the requirements and specifications for a particular metamodel according to the level of sophistication of the metamodel user. In the beginning of the metamodel requirements establishment process, the present invention avoids the need to become overly technical or overly complex. As the specifications become known and relationships are identified and better understood, the present invention makes possible becoming more specific to establish detailed logical designs for metamodel requirements capture and generation. This makes possible avoiding undue complexity in the establishment of the design requirements for a particular metamodel.

Another technical advantage of the present invention is demonstrating to the metamodel development SME audience the ongoing results of a metamodel requirements process, even prior to metamodel capture process completion and ultimate modeling tool (MT) implementation. This allows the domain SME to guide and correct the metamodel development facilitator, in the event of any misunderstanding as to the SME's model design or desires.

Other technical advantages are readily apparent to one skilled in the art from the following FIGURES, description, and claims.

### BRIEF DESCRIPTION OF THE DRAWINGS

For a more complete understanding of the present invention and advantages thereof, reference is now made to the following description which is to be taken in conjunction with the accompanying drawings and in which like reference numbers indicate like features and further wherein:

FIG. 1 illustrates a computing system that may employ the teachings of the present invention;

FIGS. 2a and 2b show a metamodel system which may employ the teachings of the present invention;

FIGS. 3a and 3b present process flows relating to the development of computer modeling systems, including the metamodel requirements capture process of the present invention;

FIG. 4 depicts in further detail a process for tailoring the metamodel requirements capture process of the present invention;

FIGS. 5a through 6 relate to a model of modeling tool metamodel (MTmm) requirements for a systems architecture as an example of metamodel requirements capture process that employs at logical design level the features of the present invention;

FIGS. 7a through 9 associate with the tailoring of a metamodel requirement capture process for a high level implementation relating to the example of a strategic information systems planning model; and.

FIGS. 10 through 15 relate to the tailoring of metamodel requirements capture process for an enterprise operations framework.

### DETAILED DESCRIPTION OF PREFERRED EMBODIMENT

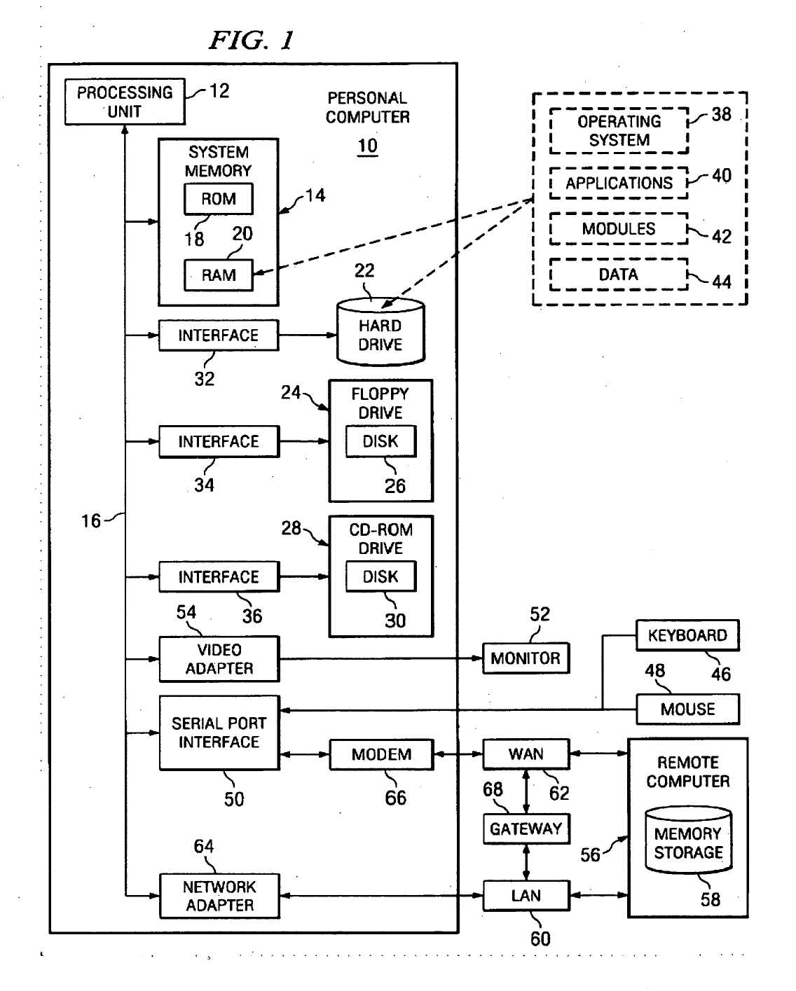

The preferred embodiment of the present invention and its advantages are best understood by referring to FIGS. 1 through 15 of the drawings, like numerals being used for like and corresponding parts of the various drawings.

FIG. 1 illustrates a general-purpose computer 10 that may use the method and system for tailoring metamodel requirements capture processing to varying users. General-purpose computer 10 may be used as a stand-alone computer or as part of a larger, networked system of personal computers such as in an enterprise. Using at least two such computers, for example, the present invention makes possible metamodel system files at different locations within a given enterprise. Here, FIG. 1 provides an understanding of how one might use the system of the present invention. General-purpose computer 10 may be used to execute distributed applications and/or distributed and individually operating system services through an operating system.

With reference to FIG. 1, an exemplary system for implementing the invention includes a conventional computer 10 (such as personal computers, laptops, palmtops, set tops, servers, mainframes, and other variety computers), including a processing unit 12, system memory 14, and system bus 16 coupling various system components including system memory 14 to the processing unit 12. Processing unit 12 may be any of various commercially available processors, including Intel x86, Pentium® and compatible microprocessors from Intel® and others, including Cyrix®, AMD® and Nexgen®; MIPS® from MIPS Technology®, NEC®, Siemens®, and others; and the PowerPC® from IBM and Motorola. Dual microprocessors and other multi-processor architectures also can be used as the processing unit 12.

System bus 16 may be any of several types of bus structures including a memory bus or memory controller, a peripheral bus, and a local bus using any of a variety of conventional bus architectures such as PCI, VESA, AGP, Microchannel, ISA and EISA, to name a few. System memory 14 includes read only memory (ROM) 18 and random access memory (RAM) 20. A basic input/output system (BIOS), containing the basic routines helping to transfer information between elements within the computer 10, such as during start-up, is stored in ROM 18.

Computer 10 further includes a hard disk drive 22, a floppy drive 24, e.g., to read from or write to a removable disk 26, and CD-ROM drive 28, e.g., for reading a CD-ROM disk 30 or to read from or write to other optical media. The hard disk drive 22, floppy drive 24, and CD-ROM drive 28 are connected to the system bus 16 by a hard disk drive interface 32, a floppy drive interface 34, and an optical drive interface 36, respectively. The drives and their associated computer-readable media provide nonvolatile storage of data, data structures, computer-executable instructions, etc. for computer 10. Although the description of computer-readable media provided above refers to a hard disk, a removable floppy and a CD, those skilled in the are may appreciate other types of media which are readable by a computer, such as magnetic cassettes, flash memory cards, digital video disks, Bernoulli cartridges, and the like, being used in the exemplary operating environment.

A number of program modules may be stored in the drives and RAM 20, including an operating system 38, one or more application programs 40, other program modules 42, and program data 44. A user may enter commands and information into the computer 10 through a keyboard 46 and pointing device, such as mouse 48. Other input devices (not shown) may include a microphone, joystick, game pad, satellite dish, scanner, or the like. These and other input devices are often connected to the processing unit 12 through a serial port interface 50 coupling to the system bus, but possibly connecting by other interfaces, such as a parallel port, game port or a universal serial bus (USB). A monitor 52 or other type of display device is also connected to the system bus 16 via an interface, such as a video adapter 54. In addition to the monitor, computers typically include other peripheral output devices (not shown), such as speakers and printers.

Computer 10 may operate in a networked environment using logical connections to one or more remote computers, such as a remote computer 56. Remote computer 56 may be a server, a router, a peer device or other common network node, and typically includes many or all of the elements described relative to the computer 10, although only a memory storage device 58 has been illustrated in FIG. 1. The logical connections depicted in FIG. 1 include a local area network (LAN) 60 and a wide area network (WAN) 62. Such networking environments are commonplace in offices, enterprise-wide computer networks, intranets and the Internet.

When used in a LAN networking environment, the computer 10 is connected to the LAN 60 through a network interface or adapter 64. When used in a WAN networking environment, computer 10 typically includes a modem 66 or other means for establishing communications (e.g., via the LAN 60 and a gateway or proxy server) over the wide area network 62, such as the Internet. Modem 66, which may be internal or external, is connected to the system bus 16 via the serial port interface 50. In a networked environment, program modules depicted relative to the computer 10, or portions thereof, may be stored in the remote memory storage device 58.

Those skilled in the art may appreciate the network connections shown as exemplary, wherein other means of establishing a communications link between the computers may be used. FIG. 1 only provides one example of a computer useful for employing the teachings of the present invention. The invention may be used in computers other than general-purpose computers, as well as on general-purpose computers without conventional operating systems.

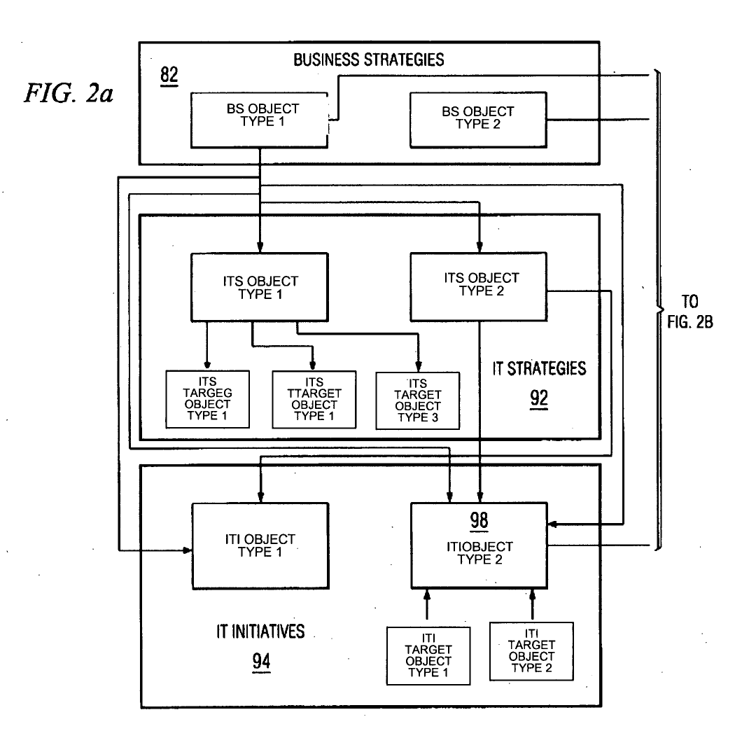

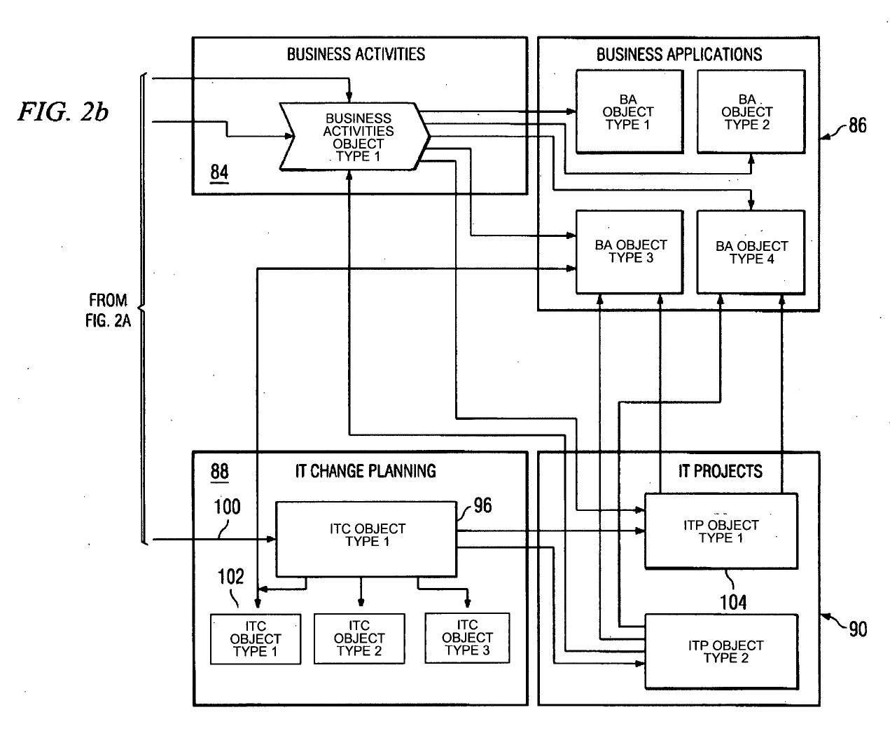

FIGS. 2a and 2b show a graphical user interface for an EDS enterprise model which employ the resulting modeling tool metamodel(MTM) generated by the process and teachings of the present invention. FIGS. 2a and 2b usefully depict general relationships and objects appearing in the various domains of an enterprise metamodel. These, for instance, may include business strategies domain 82, business activities domain 84, business applications domain 86, IT change planning domain 88, IT projects domain 90, IT strategies domain 92, and IT initiatives domain 94.

Within each domain, such as IT change planning domain 88, appear visualizations of objects, such as change plan object 96. Change plan object 96 associates with IT initiatives object 98, as relationship object or connector 100 depicts. Change plan object 96 may also associate with certain IT change planning sub-objects 102 for different functions, such as in this instance, IT change planning. Outputs from change plan object 96 may further pass to IT projects object 104 within IT projects domain 92. Thus, with metamodel graphical user interface 80, the user may create a visualization of a functional metamodel of an enterprise.

The following discussion describes in a little further detail some concepts relating to enterprise model development and its relation to implementing an enterprise taxonomy development. A model is a useful representation of some subject which provides an abstraction of reality expressed in terms of some computer system and related language. Models can provide consistent and inherently understood semantic interpretations of systems, such as, in this instance, an enterprise model (EM).

An enterprise model (EM) is a method to help determine the total impact of a requested investment on an enterprise. The model provides a structure and repeatable processes for obtaining facts and data for helping organization leaders and members to make informed decisions supporting the enterprise's particular vision. The enterprise model may include domains such as enterprise operations framework; an investment strategy; an integration roadmap and governance. The enterprise model is an integrated solution for linking business processes, data and applications across functions, geographies and business units within an enterprise. The enterprise operations framework provides a complete systems view of how an organization operates today and in the future to achieve its vision of becoming the global leader in the digital economy. It is the foundation for the overall systems design and operation, and represents how an organization will operate, verifies the systems current operational state, and indicates where and how current initiatives are changing the systems base. The enterprises operation framework provides the structure and repeatable methods to employ other components of the enterprise model, such as the investment strategy, the integration roadmap or the governance. Therefore an EM provides a visual modeling tool allowing a user to understand increasingly complex enterprises. This enables decision makers and those who carry out the work of an enterprise to share a common understanding, all represented as a visual model. The model forms the basis for making informed decisions, since it becomes possible to reveal the complex interplay within the enterprise.

A metamodel is a definition or collection of definitions for using the objects and relationships in a model such as an enterprise model. Specifically, a metamodel defines object types, relationship types, methods and criteria useful for searching a model. Metamodel information related to a particular area of knowledge may be grouped into domains or packages. The model includes references to specific MTM domains to designate which object types, relationship types, methods, and search criteria can be used in a model. A metamodel system is designed to accommodate the diverse needs in large corporations. The structure of the metamodel system includes a model editor module, which allows the user to build and maintain models. The metamodel designer module has features for customizing metamodels via textual definitions.

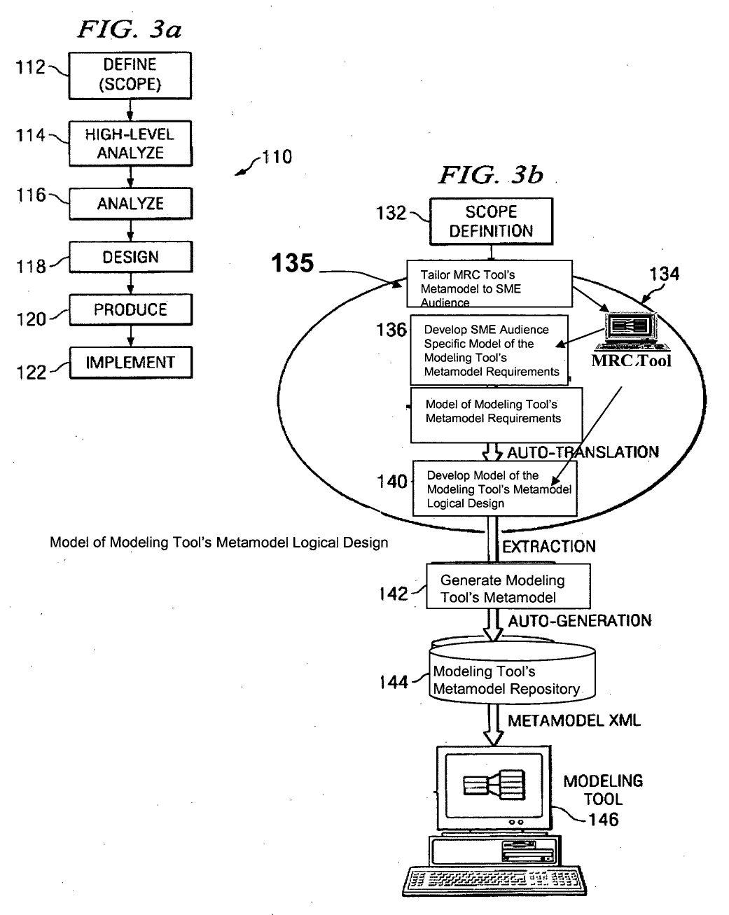

FIG. 3a presents systems development process flows relating to the development of business applications and FIG. 3b depicts the metamodel requirements capture process of the present invention and the metamodel generation process. FIG. 3a shows SDLC flowchart 110 as an illustrative system development lifecycle, which begin at definition step 112. After, high level analyze step 114, SDLC flowchart 110 goes to analyze step 116. Design step 118 follows analyze step 116 after which produce step 120 occurs. Finally, at step 122, implementing the developed system design occurs.

The systems development life cycle of FIG. 3a represents a way of developing a computer system and contrasts with the metamodel requirements capture process of the present invention. Design step 112 establishes what the particular computer system will achieve and what it will not achieve, as well the functions that the computer system will include and exclude. Design step 122 further establishes the outcome for the particular computer system. High level analyze step 114 involves defining first level requirements for the particular computer system. Whereas the scope is the general understanding of what the computer system will do, high level analyze step 114 represents the point at which the life cycle defines the high level functionality within that particular scope. At analyze step 116, the SDLC flowchart 110 establishes the particular language and the approach for implementing the functionality of a particular system.

Interacting with the particular customer occurs at high level analyze step 114. This ensures that the resulting analysis step 116 and design step 18 achieved a thorough understanding and integration of the customer's input. In analyze step 116, a detailed specific architectural design for the system in development occurs. The architecture establishes the context in which the system will be implemented. This step, therefore, provides input for the design in the design step 118 and produce step 120.

In analyze step 116, a clear, articulate, detailed specification of the requirements for a particular software application or customer arises. Design step 118 includes identifying a particular software system for implementing the design. Furthermore, in the traditional design step 118, while usually being language independent, it may be helpful to know what the platform for the system will be and how such a platform may affect the ultimate software or modeling system. The traditional produce step 120 employs tools for writing the software code. This results in a system ready for implementation at step 122.

In contrast, the metamodel development lifecycle 130 appears in FIG. 3b. Metamodel development lifecycle 130 incorporates the metamodel requirements capture, or “MRC,” process of the present invention, which begins with scope definition step 132. From scope definition step 132, metamodel development lifecycle 130 leads to MRC process 134. This includes Tailor MRC Tool's Metamodel to SME Audience step 135, Develop SME Audience Specific Model of the Modeling Tool's Met model Requirements step 136, followed by Develop Model of the Modeling Tool's Metamodel Logical Design step 140. MRC process 134 may provide metamodel requirements for automated metamodel generator process 142, which is described in U.S. patent application Ser. No. ______ Mar. 13, 1993 by Brent D. Nelson and assigned to EDS Corporation, filed on September ______ , 2003.

Automated metamodel generator step 142, a results in a repository of metamodel files 144. These metamodel files are supplied to modeling tool 146, which may reside on a general purpose personal computer, such as the one described above in FIG. 1.

Scope definition 132 step yields a definition of what will be dealt with and what will not be dealt with in the particular metamodel development. Scope definition step 132 may involve the use of some particular subject matter experts for the purpose of establishing the particular definition of the metamodel. Scope definition step 132 identifies the information from which to establish a metamodel system. Within the metamodel requirements capture process 134 of the present invention.

For the complete metamodel requirements capture, or MRC, process of the present invention, the first step is to tailor the MRC capture tool according to the capabilities of the audience of SMEs. This includes establishing who and what are the abilities of the SMEs who provide the requirements for metamodel development, as well as what the SMEs desire to achieve through the metamodel system. Thus, the present invention allows for the determination of whether to directly proceed to MRC process step 140 Develop Model of the Modeling Tool's Metamodel Logical Design or whether to begin the MRC process 134 at Develop SME Audience Specific Model of the Modeling Tool's Metamodel Requirements step 136.

With MRC process 134 of the present invention, the SME audience may readily see what relationship exists between different object types, as well as which relationship types are incorrect or need modification. Because MRC process 134 is graphically oriented, an SME may also readily see what changes need to occur during the process of capturing metamodel requirements. MRC process 134 allows a metamodel developer to facilitate a large SME group by addressing how that group intends to capture the particular requirements.

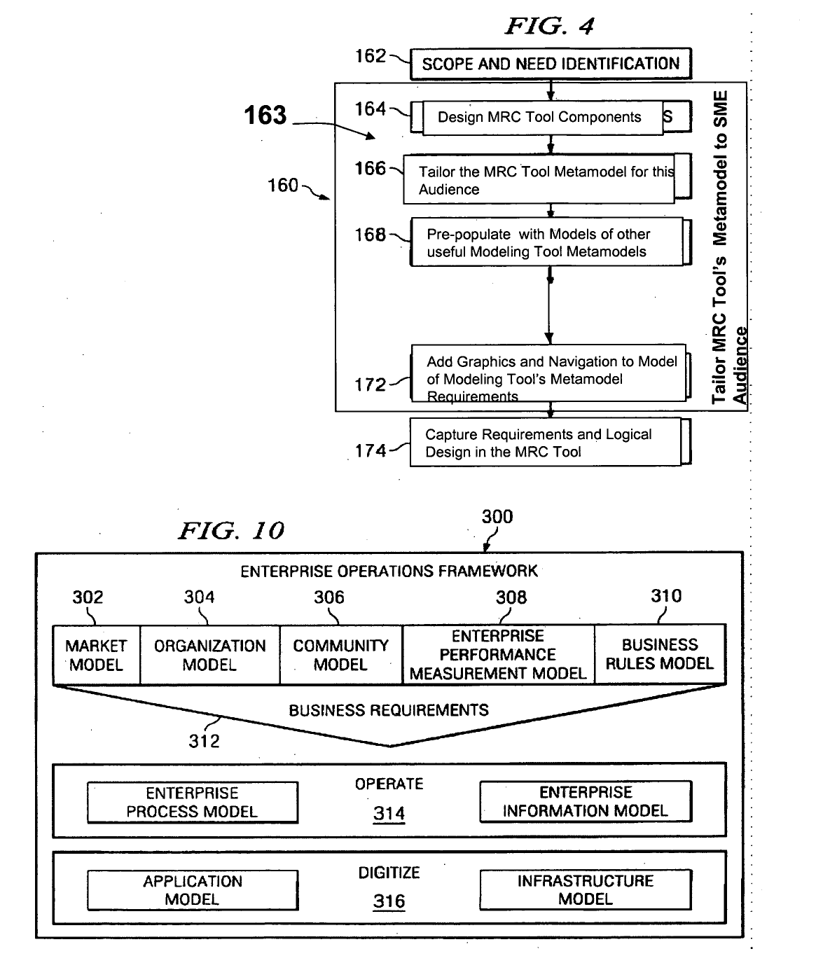

FIG. 4 depicts MRC process 134 in further detail in flowchart 160, which begins at step 162 for defining the scope and the need of the particular metamodel user. Next, in steps 164 through 172 are the details of MRC process 134 step 135, Tailor MRC Tool's Metamodel to SME Audience. In step 164 the design of the MRC Tool Components occurs. This includes layout, navigation, graphics, level of detail, type representations and any other unique needs that will help in the capture of the Modeling Tool's (MT) metamodel requirements. Tailoring the MRC Tool's metamodel for the particular audience occurs at step 166. Then, the present invention provides for the integration of existing models of other MT metamodels into this occurrence of the model of the MT metamodel requirements, at step 168. Then, at step 172, the step of adding graphics and navigations to the model of the MTM requirements occur. Thereafter, the capture process concludes with the step of capturing the requirements and/or logical design in the MRC tool, at step 174.

MRC process flow 160, therefore, shows that MRC process 134 may be tailored to the particular stage of conceptual and programming sophistication a metamodel SME audience may possess. Referring to FIG. 4, MRC process flow 160 includes a first step 162 of scope and need identification relating to the particular implementation of MRC process 134. The design of the MRC component happens at step 164. This step may include determining the stage of metamodel development, the scope of the metamodel development, and the appropriate familiar representation for a predetermined set domain SMEs. Determination of the extent of the UML language that this audience may tolerate, as well as the navigation requirements for the particular MRC technique, occurs at step 164.

At step 166, the tailoring of the MRC Tool metamodel occurs to match the situation and needs of the particular SME audience. This involves the step of developing a metamodel view that limits the degree of UML language usage. The tailoring process may also involve setting up metadata properties, as well as objective type graphics that may be specific to this SME audience.

At step 168, in preparation for the capture of an MT metamodel requirements model, pre-populating of useful existing models of MT metamodels into the MRC Tool occurs. Step 172 further prepares by adding graphics and navigation to the pre-populated model of MT metamodel requirements, as well as a navigation menu. Step 174 involves the capture of requirements in the MRC tool by developing an SME audience specific model of the desired MT's metamodel requirements and/or logical design. This involves the use of this tailored MRC Tool to facilitate the SMEs in capturing the new MT's metamodel requirements and/or logical design.

Detailed design step 140 of MRC process 134 includes specifying the requirements for the automated MT metamodel generator function step 36. From these requirements and using the automated MT metamodel generator 142, MRC process 134 leads to creation of a MT metamodel file repository 144. Although the present invention uses XML for the metamodel files, other languages than known markup languages may be used.

In scope and need identification step 162 of FIG. 4, MRC process 134 determines if the SME is familiar with UML, then using UML in MRC process 134 may be appropriate. On the other hand, if the SME audience is not familiar with UML a simplified representation may be more appropriate.

The present invention accommodates these different levels of UML sophistication.

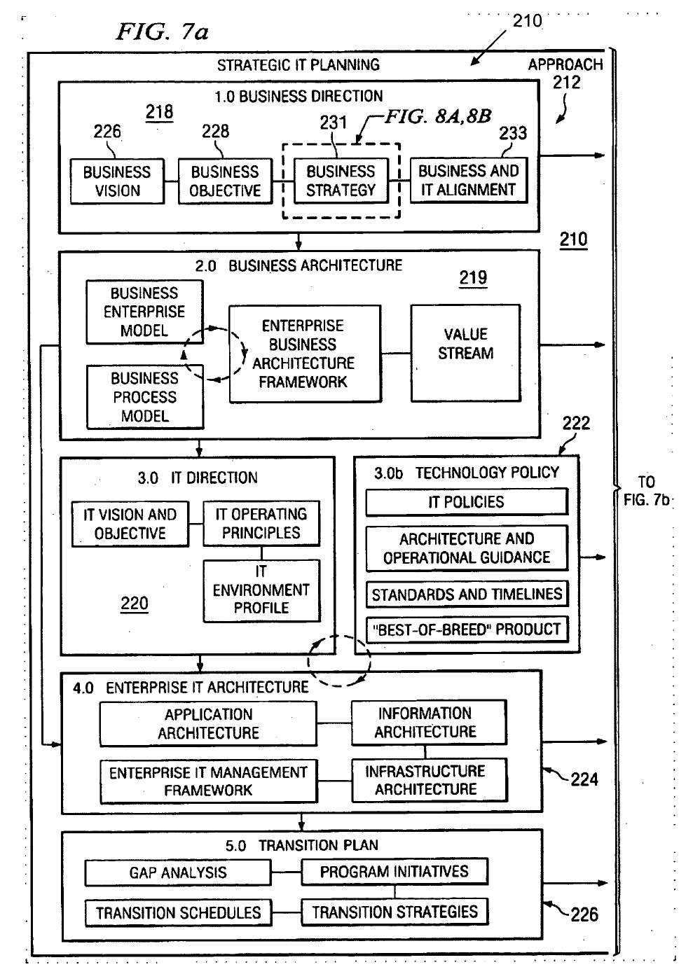

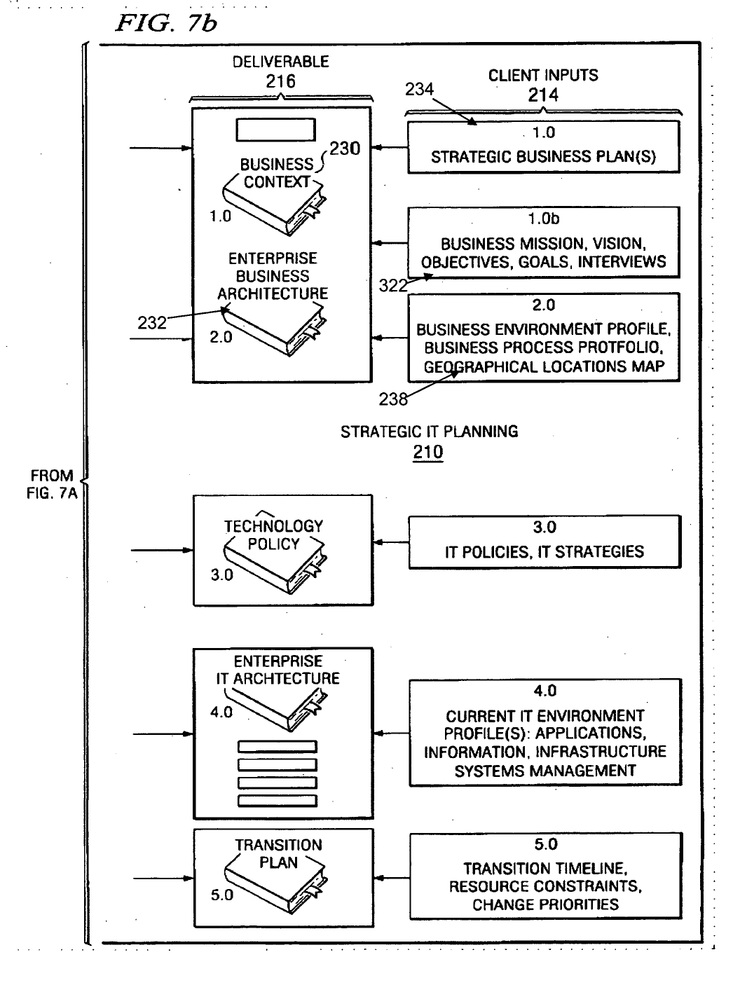

For example, a Microsoft® PowerPoint® graphic may provide the basis for a navigation tool for a particular audience of MRC process 134. Such a graphical display may be consistent with the SME's particular understandings. Using such an activated and linked representation may direct requirements capture session to an associated portion or component of the metamodel system. The example of FIGS. 7 through 9, below, describes this functionality more specifically.

Referring again to FIG. 4, within tailoring step 166, the process of tailoring an MRC Tool metamodel involves the implementation of this familiar navigational representation that the SME can appreciate. Thus, once, in step 166, the extent of UML required is determined, and only the appropriate, level of UML is provided. In tailoring step 166, the prescribed model may determine the particular object type information and object view information for the object types to become part of the resulting MRC Tool metamodel.

In step 168, models of MT metamodels that may already exist and be available for inclusion into a new MT metamodel may be gathered and made available for integration into the resulting model of MT metamodel requirements. This allows for the use of preexisting MT metamodels that may be productively employed to capture additional metamodel requirements.

In step 172, any graphics with which the SME audience is familiar may then be included in the new model of the MT metamodel requirements. In step 174, a facilitated session for the purpose of capturing the requirements in the MRC tool results in a population of the associated model of the MT metamodel requirements and/or logical design. Requirements are collected and prepared for delivery to the metamodel generator process.

NRC process 134 step 136 permits working with facilitators and metamodel SMEs to determine how they desire to capture the specific requirements using the MRC Tool. In particular, for a model of MT metamodel requirements with complex relationship types and a high number of object types, it may be appropriate to interview the different SMEs to determine their particular needs. In such an event, it is often the case that some relationship types are well-defined, whereas other relationship types are not defined or not particularly well understood. The present invention takes this into consideration by establishing requirements that may be defined further be defined as the metamodel becomes more established or complete in step 140. For relationship types that are not yet fully understood, the present invention allows specifying what is or can be known about a particular relationship type. This cataloging of information promotes further understanding and development of relationship types between object types.

Another advantage of the present invention is the ability to incorporate the existing graphics SMEs may already employ. The present invention also takes into consideration the sophistication of the tool that a user might employ in capturing the MT metamodel requirements.

MRC process 134 of the present invention also permits tailoring the requirements and specifications in a particular MT metamodel requirements model according to the level of sophistication of the domain SME. As the specifications become known and relationships are identified and better understood, the present invention makes it is possible to be more specific and more technical.

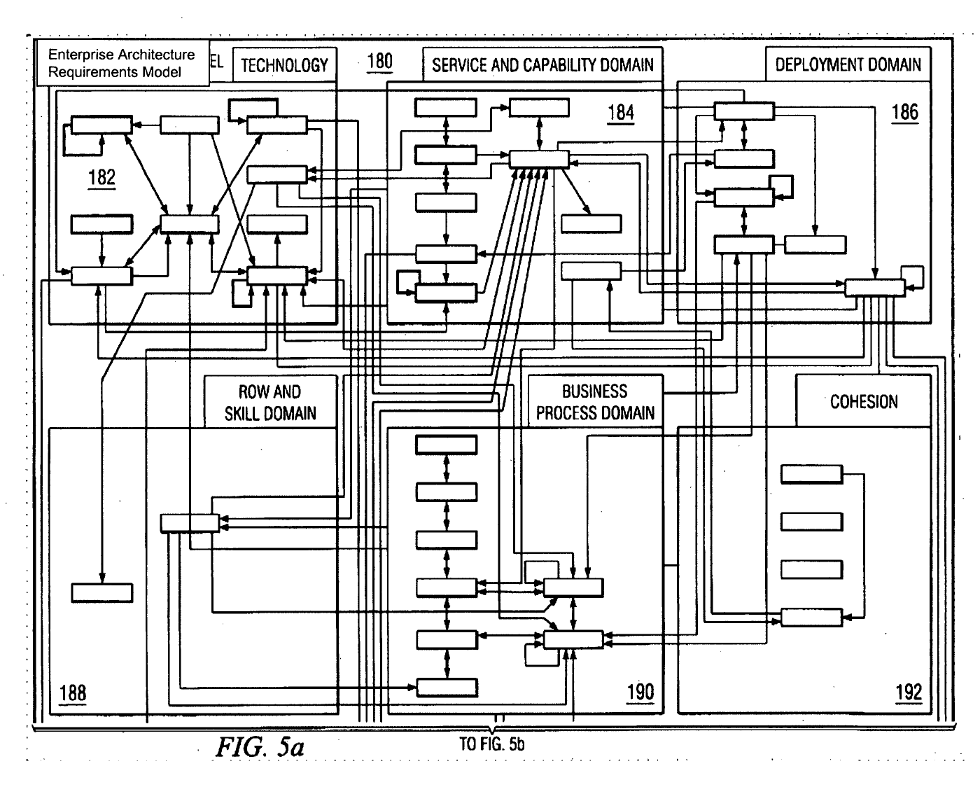

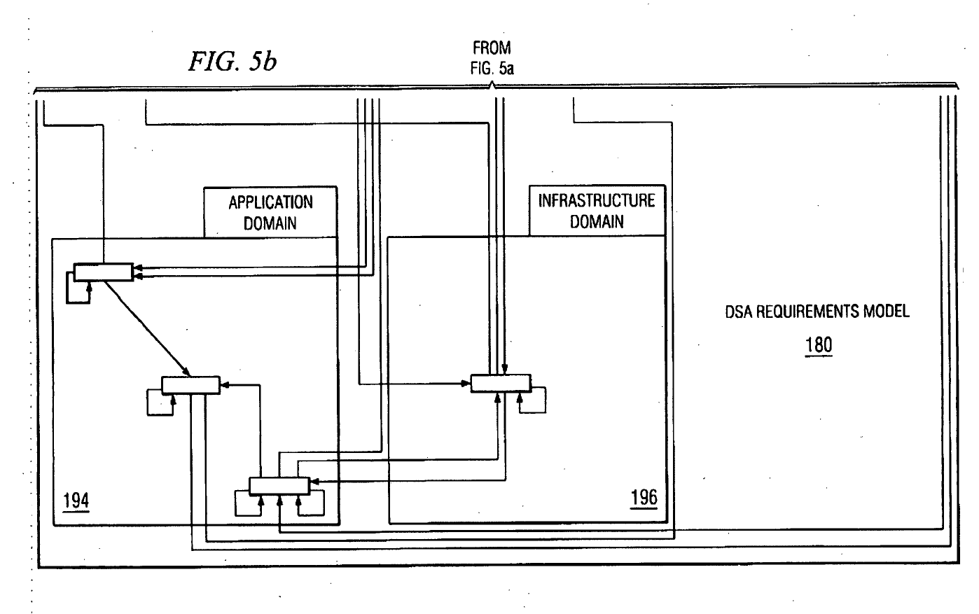

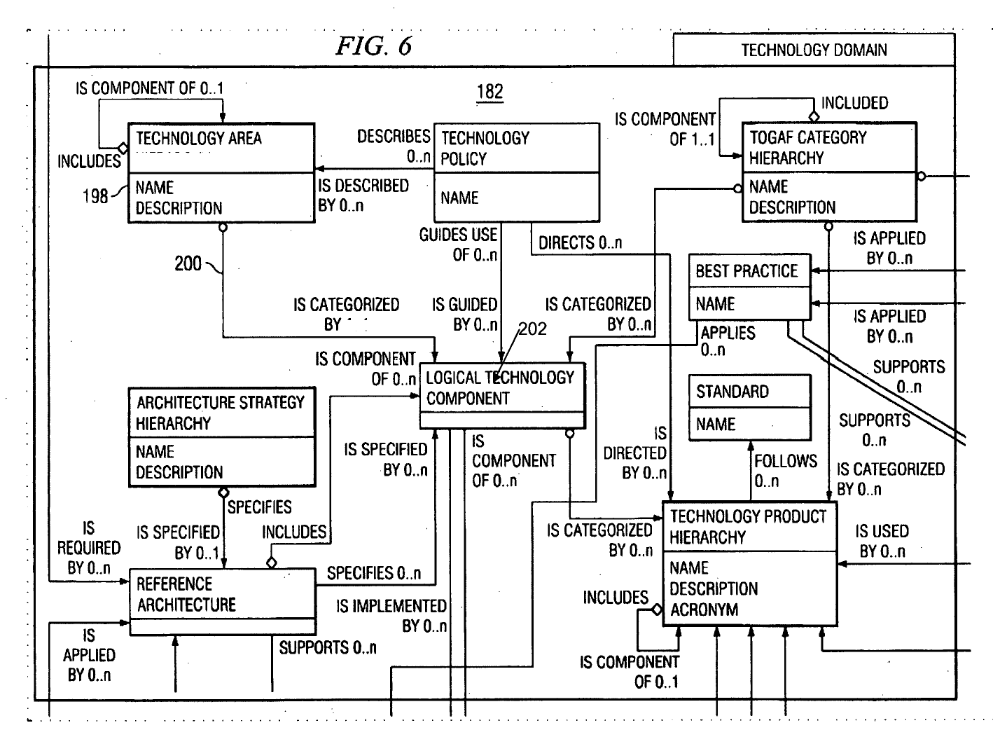

Now, moving from the tailoring of the MRC Tool to the use of the MRC Tool to develop audience specific metamodel requirements and logical designs, FIGS. 5a, 5b, and 6, therefore, relate to a MRC process 134 that begins at logical design MRC step 140. FIGS. 5a and 5b, in particular, illustrate one example of a set systems architecture domains of an enterprise architecture metamodel requirements model 180.

The example enterprise architecture metamodel requirements model 180 shows a set of different domains which may include preexisting and planned metamodels which MRC process 134 step 135 is set up to support. These would include Technology domain 182, Service and Capability domain 184, Deployment domain 186, Role and Skill domain 188, Business Process domain 190, Cohesion domain 192, Application domain 194, and Infrastructure domain 196. These individual models of domain metamodels may relate to one another as the various lines depict. Furthermore, these different domains may include various object types, which object types are shown in exemplary fashion more particularly in FIG. 6.

FIG. 6 shows a more detailed example within the Technology domain metamodel model 182 where there are numerous object types such as Technology Area object type 198, Technology Policy object type 199, Logical Technology Component object type 202, and others. A relationship between Technology Area object type 198 and Logical Technology Component object type 202 may be, for example, “Is Categorized By” relationship 200. “Is Categorized By” relationship 200 may establish Technology Area object type 198 as an origin object and as a Logical Technology Component object type 202 target object.

With the level of specificity in this example of detailed design MRC step 140, it is possible to create a set of metamodel object type and relationship type files from which to generate a new metamodel.

FIGS. 7a through 9 show an example of using MRC process 134 to tailor the MRC Tool metamodel to support the development of a strategic information technology planning MT metamodel.

The Strategic IT Planning display 210, in its original form, was simply a PowerPoint® presentation familiar to the specific SME audience that intends to use the MRC Tool to capture metamodel requirements and/or logical design. This graphic will be used to navigate via hyperlink to the corresponding domains within the model of the MT metamodel requirements.

In the example of the Strategic IT Planning display 210, a separate visualization based on the associated PowerPoint® slide shows that Business Direction component 212 includes items such as Business Vision 226, Business Objectives item 228, Business Strategy item 231, and Business & IT Alignment item 233. In this illustrative implementation of the present invention, Business Strategy component 231 links to a specific web site where the domain SME may document relevant knowledge of the Business Strategy function corresponding to Business Strategy metamodel domain model 240 of FIG. 8.

Referring to FIG. 8 as an example of using the MRC Tool to capture metamodel requirements, the Business Strategy metamodel domain 240 contains, for example, Vision object type 246 and Mission Object type 248, between which “derived from” relationship type 250 associates.

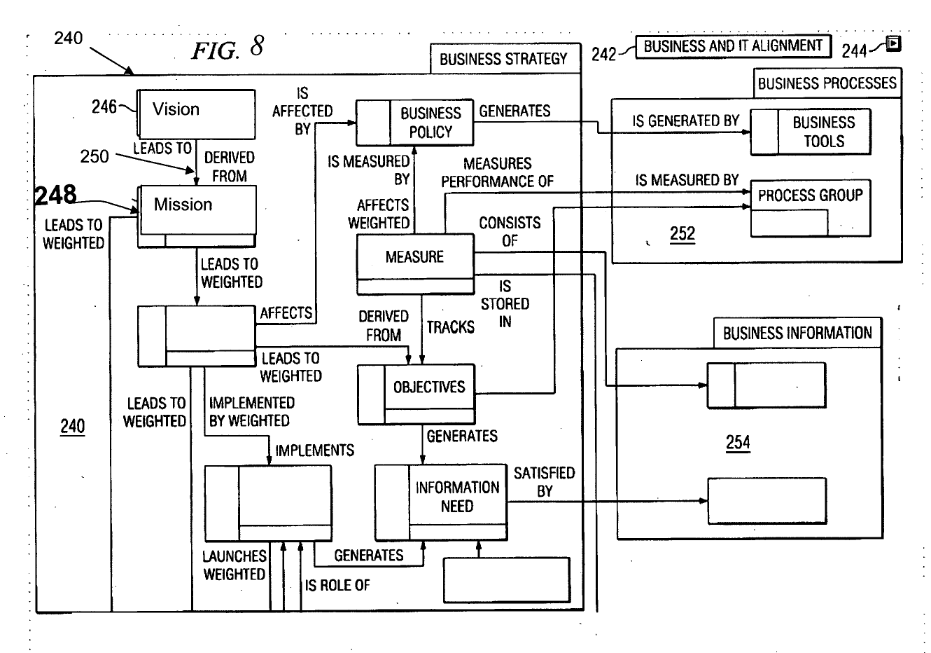

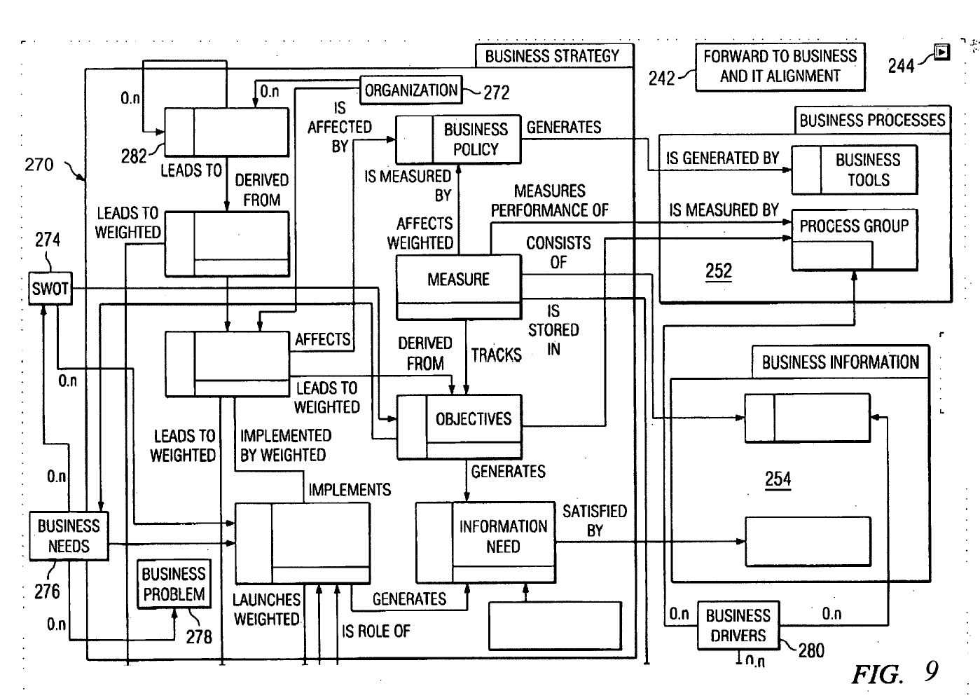

FIG. 8 also shows how a metamodel might appear for implementing MRC process 134. Here, creating a wholly new metamodel may be needed. Instead, MRC process 134 for FIG. 8 augments the business strategy metamodel 240 for this business context. FIG. 9 illustrates the modification of an existing metamodel domain such as Business Strategy domain 240 to create a modified Business Strategy domain MT metamodel requirements model 270. In order to provide this functionality, the present invention for example would provide the SMEs the ability to associate numerous additional object types with Business Strategies domain 240 to yield modified Business Strategies domain 270. These new object types may associate with existing object types within the modified Business Strategy domain 270, as well as with other object types within the various domains, such as Business Processes domain 252 or Business Information domain 254.

Thus, by simply presenting to an SME a display with which they are familiar such as, for example, strategic IT planning display 210 of FIG. 7, the present invention contemplates the modification of an existing MRC Tool for the purpose of creating or facilitating the populating an associated model of MT metamodel requirements and/or logical design. FIG. 7, moreover, shows an exemplary implementation of how the present invention may provide for the tailoring of the MRC navigation menu, but at a different level from the example of FIGS. 5 and 6.

FIGS. 10 through 15 relate to the tailoring of metamodel requirements capture tool and process for an enterprise operations framework. FIG. 10 illustrates where MRC Process 134 may include the SME familiar graphic for capturing requirements of an enterprise architecture modeling tool metamodel. In the example of FIG. 10, the SME would not have the level of modeling and metamodeling sophistication possessed by a user discussed above in the MT metamodel logical design model, FIGS. 5 and 6. Thus, FIG. 10 shows Enterprise Operations Framework diagram 300 which may include an assemblage of models such as Market Model 302, Organization Model 304, Community Model 306, Enterprise Performance Measurement Model 308, and Business Rules Model 310. Within Enterprise Operations Framework 300, a modeler may assemble or associate various models for creating different metamodels for different business requirements 312 that relate to the operation of Enterprise Operations Framework 300. These may include Operate Framework 314, including Enterprise Process model 315 and Enterprise Information model 317, as well as Digitize framework 316, including Application Model 319 and Infrastructure Model 321.

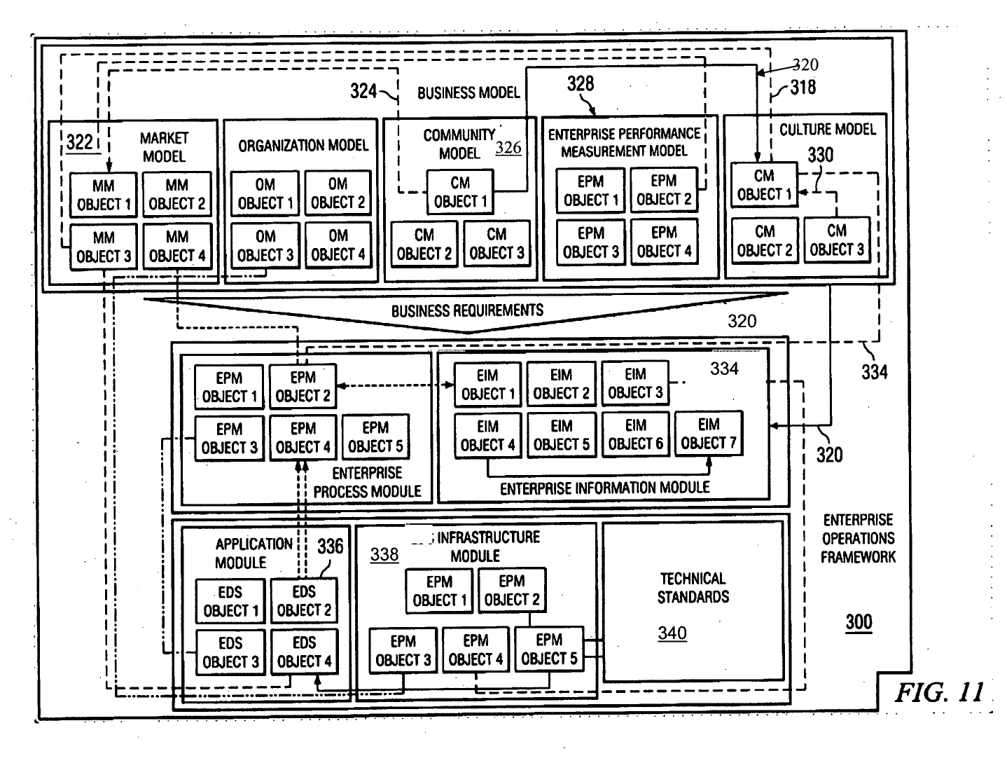

Within the context of FIG. 10, FIG. 11 illustrates a model of MT metamodel requirements incorporating the concepts of Enterprise Operations Framework model 300 tailored to the sophistication of the SME of this domain.

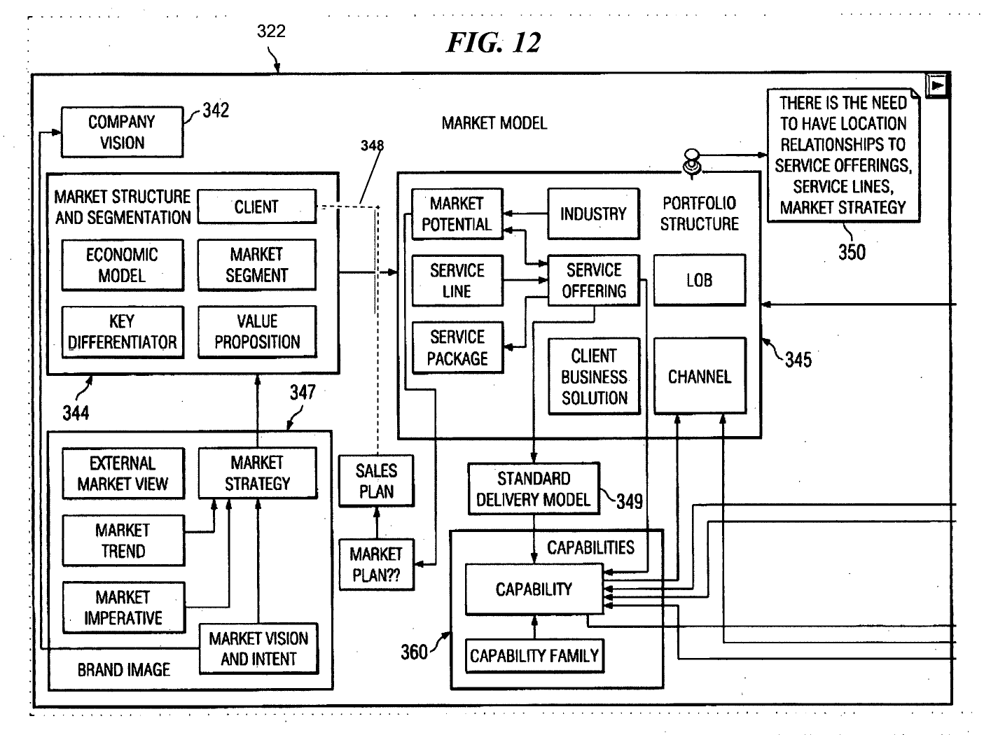

To more particularly understand how the metamodel requirements capture process in the example of FIGS. 10 and 11 may function, FIGS. 12 provides a further view of the Market domain of the MT metamodel requirements model 322. In Market metamodel requirements model 322, associated object types include Vision object 342, Market Structure and Segmentation domain 344, Portfolio Structure domain 345, Brand Image object type 347 and Capabilities object type 349. Relationship types within Market metamodel requirements model 346 may include those that may not be completely specified indicated here by a dashed line, such as relationships 348. The SMEs for this particular model of metamodel requirements were aided by the dashed line visual to indicate further refinement is needed to the relationship type. To show the population of the Market metamodel requirements model 322, FIG. 12 indicates, at Portfolio Structure domain 345, the need for location relationships to service offerings, service lines and market strategy, as block notes to the facilitator 350 indicates.

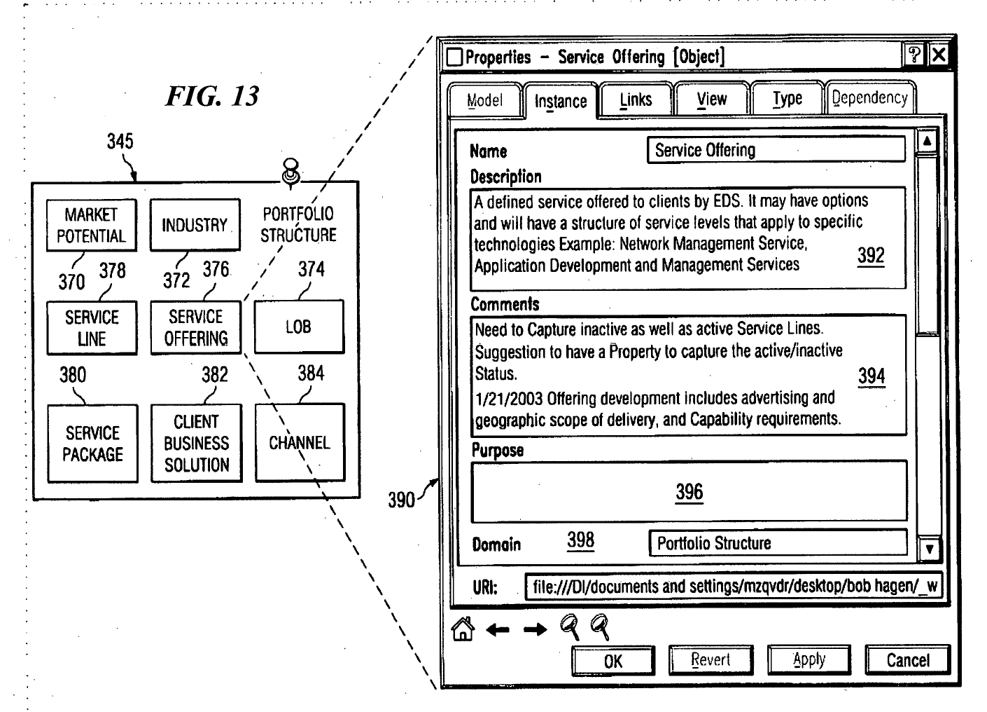

To satisfy these needs, FIG. 13 provides a further view of Portfolio Structure domain 345, through which the present invention captures MT metamodel metadata using a series of forms for an SME or facilitator to populate.

for example upon activating Service Offering metadata form 376, FIG. 13 further shows that the SME is presented with the upper portion of a three-part metadata form 390. Metadata forms are tailored in step 135

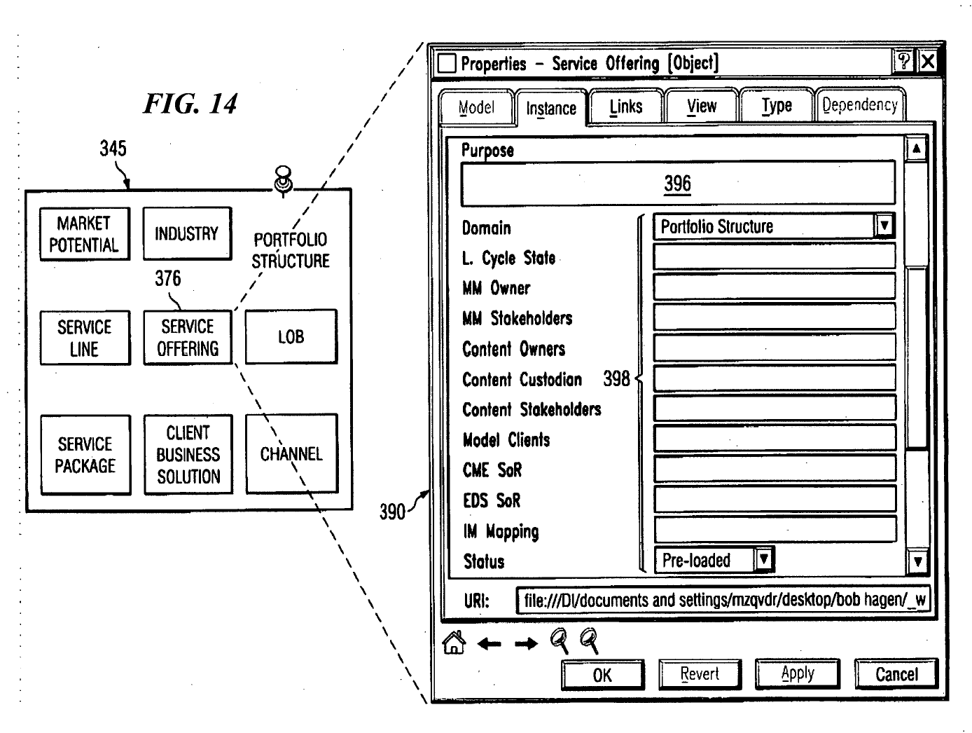

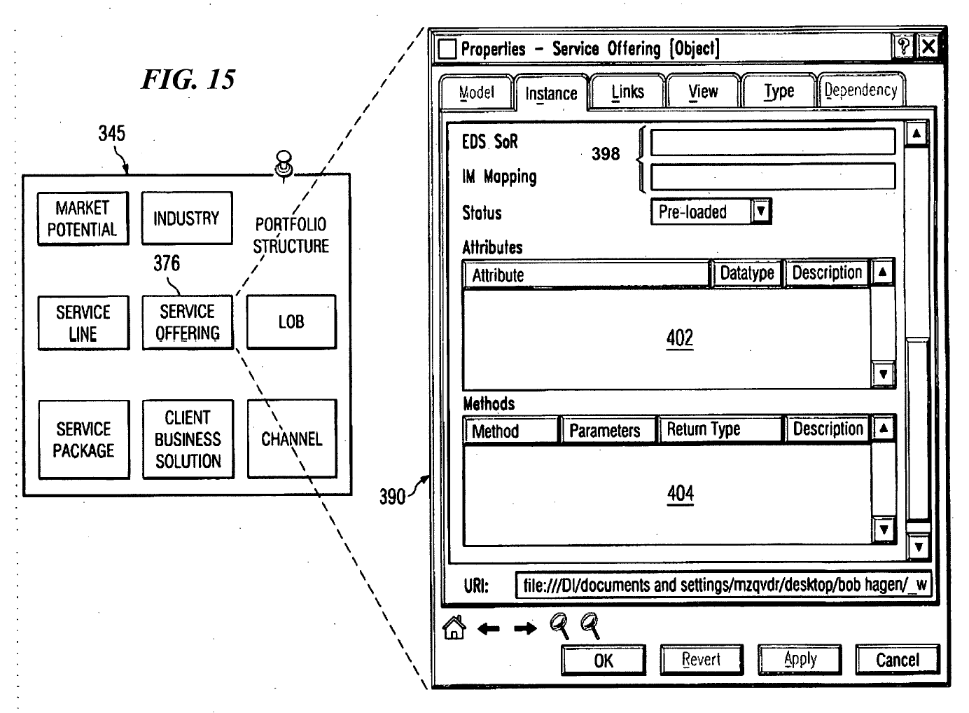

FIGS. 14 and 15 provide, respectively, examples of the middle and lower portion of Service Offering metadata form 376 within Portfolio Structure object 345. In particular, FIG. 15 shows metadata form display 390 at the middle portion to include Purpose field 396. Also, metadata form display 390 includes various fields 398 for populating Service Offering metadata form 376 with information such as the Domain, the Lifecycle State, the metamodel owner and related information.

Finally, FIG. 15 shows the bottom portion of metadata form display 390 relating to Service Offering metadata form 376 of Portfolio Structure object 345. In this example, the further population of Attributes field 402 may include, for example, such information may be attribute data type and description information for capturing the respective metamodel requirements for an Enterprise Operations Framework 300 metamodel. Moreover, Methods field 404 may include information such as the method, parameters, return type and description of the particular methods that the metamodel would require. Thus, the present invention permits populating various metadata forms that would result in information for object types useful in different MRC tool metamodels, such as a metamodel supporting Enterprise Operations Framework 300.

MRC process 134 of present invention, therefore, provides a method and system to identify, document, and design any kind of metamodel requirements for the purpose of generating a working metamodel. The present invention overcomes the present limitation of only being able to perform text-based metamodel development and may be generalized to a number of metamodeling systems with the expanded use of an automated metamodel file generating system.

Accordingly, it is to be understood that the embodiments of the invention herein described are merely illustrative of the application of the principles of the invention. For example, although the present embodiment employs one or more versions of the Metis® metamodeling system, those metamodeling systems made by Visio, CaseWise®, Popkin®, and Slate® may as example also employ one or more embodiment of the present invention. The preferred embodiment, therefore, may be modified or changed by using Visual Basic.Net® instead of Excel® formulas and VBA® formulas. Reference herein to details of the illustrated embodiments, therefore, is not intended to limit the scope of the claims, which themselves recite those features regarded as essential to the invention.

1. A variable method for capturing and developing metamodel system requirements according to the capabilities of a predetermined set of metamodel users, comprising the steps of:
identifying a set of metamodel requirements for information useable by a system metamodel;
associating a plurality of metamodel requirements components with said metamodel requirements;
tailoring said plurality of metamodel requirements components to a predetermined set of metamodel users to produce a tailored plurality of metamodel requirements components; and
graphically representing said tailored plurality of metamodel requirements components for use by said predetermined set of metamodel users.

2. The method of claim 1, further comprising the step of integrating a set of pre-existing metamodel requirements components into said tailored plurality of metamodel requirements components.

3. The method of claim 1, further comprising the step of organizing said tailored plurality of metamodel requirements components for receiving metamodel requirements inputs from a metamodel user within said predetermined set of metamodel users.

4. The method of claim 1, further comprising the step of identifying a stage of system metamodel development applicable to said predetermined set of metamodel users.

5. The method of claim 1, further comprising the step of associating a plurality of object type metadata properties with said plurality of metamodel requirements components.

6. The method of claim 1, further comprising the step of associating a plurality of object views/graphics with said plurality of metamodel requirements components.

7. The method of claim 1, further comprising the step of tailoring said plurality of metamodel requirements components by aggregating existing metamodel requirements components into said plurality of metamodel requirements components.

8. The method of claim 1, further comprising the step of adding said tailored plurality of metamodel requirements components to a set of domain specific models of the associated metamodel.

9. A metamodel system requirements capture and development system for capturing and developing metamodel system requirements according to the capabilities of a predetermined set of metamodel users, comprising:
identification means for identifying a set of metamodel requirements for information, said information for use by a system metamodel;
associating means for associating a plurality of metamodel requirements components with said metamodel requirements;
tailoring means for tailoring said plurality of metamodel requirements components to a predetermined set of metamodel users; and
a graphical user interface for graphically representing said tailored plurality of metamodel requirements components for use by said predetermined set of metamodel users.

10. The system of claim 9, wherein said identifying means further comprise means for identifying the stage of system metamodel development applicable to said predetermined set of metamodel users.

11. The system of claim 9, wherein said associating means further comprise means for associating a plurality of object type metadata properties with said plurality of metamodel requirements components.

12. The system of claim 9, wherein said associating means further comprise means for associating a plurality of object views with said plurality of metamodel requirements components.

13. The system of claim 9, wherein said tailoring means further comprise means for tailoring said plurality of metamodel requirements components by aggregating existing metamodel requirements components into said plurality of metamodel requirements components.

14. A metamodel system requirements capture and development system for capturing and developing metamodel system requirements according to the capabilities of a predetermined set of metamodel users, comprising:
a set of identified metamodel requirements for information, said information for use by a system metamodel;
a plurality of metamodel requirements components associated with said identified metamodel requirements;
a plurality of tailored metamodel requirements components tailored to a predetermined set of metamodel users; and
a graphical user interface for graphically representing said tailored plurality of metamodel requirements components for use by said predetermined set of metamodel users.

15. The system of claim 14, wherein said set of identified metamodel requirements identify a stage of system metamodel development applicable to said predetermined set of metamodel users.

16. The system of claim 14, wherein said set of identified metamodel requirements identify a scope of system metamodel development applicable to said predetermined set of metamodel users.

17. The system of claim 14, wherein said plurality of metamodel requirements components further comprise means for associating a plurality of object type metadata properties with said plurality of metamodel requirements components.

18. A storage medium comprising a metamodel system requirements capture and development system for capturing and developing metamodel system requirements according to the capabilities of a predetermined set of metamodel users, said storage medium comprising:
identification instructions for identifying a set of metamodel requirements for information, said information for use by a system metamodel;
associating instructions for associating a plurality of metamodel requirements components with said set of metamodel requirements;
tailoring instructions for tailoring said plurality of metamodel requirements components to a predetermined set of metamodel users; and
graphical user interface instructions for graphically representing said tailored plurality of metamodel requirements components for use by said predetermined set of metamodel users.

19. The storage medium of claim 18, further comprising instructions for tailoring said plurality of metamodel requirements components by aggregating existing metamodel requirements components into said plurality of metamodel requirements components.

20. The storage medium of claim 18, wherein said set of identified metamodel requirements identify a scope of system metamodel development applicable to said predetermined set of metamodel users.
